(19) United States
(12) Patent Application Publication
(10) Pub. No.: US 2008/0197523 A1
(43) Pub. Date: Aug. 21, 2008

(54) SYSTEM AND METHOD FOR MANUFACTURING COMPOSITE MATERIALS HAVING SUBSTANTIALLY UNIFORM PROPERTIES

(75) Inventors: Robert W. Heigel, Pataskala, OH (US); Scott A. Haemmerle, Cincinnati, OH (US); William G. Taylor, Columbus, OH (US); Bryan Wright, Ashville, OH (US)

Correspondence Address: STANDLEY LAW GROUP LLP, 495 METRO PLACE SOUTH, SUITE 210, DUBLIN, OH, 43017, US

(73) Assignee: Crane Plastics Company LLC, Columbus, OH (US)

(21) Appl. No.: 11/676,913

(22) Filed: Feb. 20, 2007

(51) Int. Cl. B29C 45/76

(52) U.S. Cl. 264/40.4; 425/116; 425/135; 425/148

(57) ABSTRACT

A system and method for manufacturing composite material components having substantially uniform properties comprising means to control the metering of constituent composite material components during manufacture. The resulting composite material components may, for example, be used in the construction of decking systems, railing, porches, fences, stairs, or other similar or suitable applications that may benefit from aesthetically pleasing appearances.

### BACKGROUND AND SUMMARY OF THE INVENTION

Exemplary embodiments of the present invention relate generally to composite products. More particularly, exemplary embodiments of the present invention include systems and methods directed to the control of manufacturing processes used to manufacture composite materials such as cellulosic-filled and/or inorganic-filled plastic composites. Such composite materials have a wide range of application and may, for example, be used in the manufacture of gates, fences, porch and deck skirts, and other similar or suitable structures.

A major problem with the use of wood materials in structural applications is their lack of durability and the degradation in appearance when exposed to the environment. Wood materials are particularly attractive due to their intrinsic beauty of their wood grain. However, in the example of residential decks, rain can infiltrate exposed surfaces of the wood components, which may eventually cause rot and the loss of a pleasing aesthetic appearance. Traditional wood surface treatments, such as paint or lacquers, have limited life and require routine maintenance, which can result in significant expense over time. Additionally, wood decking systems, for example, are typically custom-built on-site, thereby requiring significant amounts of labor to custom-cut and install individual components. More recently, pre-engineered cellulosic-filled and/or inorganic-filled plastic composites have been developed to overcome such deficiencies. As compared to natural woods, a cellulosic composite may offer superior resistance to wear and tear and to degradation caused by adverse weathering effects, which reduces overall maintenance costs. For instance, a cellulosic composite may have an enhanced resistance to moisture. In fact, it is well known that the retention of moisture is a primary cause of the warping, splintering, and discoloration of natural woods as described above. Moreover, a cellulosic composite may be sawed, sanded, shaped, turned, fastened, and finished in a similar manner as natural woods.

The manufacturing process needed to produce such composite materials may, for example, include the mixing and extrusion of a base plastic resin and cellulosic filler, such as polyvinylchloride (PVC) and wood flour, as well as the addition of other components, such as but not limited to, colorants and lubricants. During the process, the components are typically mixed by introduction into a mixer, preheater, and/or extruder to produce a product having desired characteristics, such as strength, rigidity, color, etc. Of particular importance is the production of composite materials that have a consistently and substantially uniform density and color, which are currently maintained by a manual metering of components as they are introduced into the manufacturing process. However, since the production of extruded composite materials is generally a continuous process, undesirable density variation in the final product occurs because density variations of the introduced base components occur over relatively short time periods. In particular, the components cannot be adequately metered real-time for compensation of variations during mixing by manual operator control. For similar reasons, the control of color is difficult as the amounts of colorants cannot be satisfactorily controlled real-time, producing undesirable variation in color in the final product. Consequently, there is a need for a system and method by which to adequately control the characteristics of an extruded composite material in a real-time manner to produce products having substantially uniform density, color, and/or other desired properties.

Exemplary embodiments of the present invention may satisfy some or all of the above needs. Exemplary embodiments of the present invention include systems and methods for manufacturing composite material components having substantially uniform properties comprising means to control the metering of constituent composite material components during manufacture. The resulting composite material components may be used, for example, in the construction of decking systems, railing, porches, fences, stairs, or other similar or suitable applications that may benefit from aesthetically pleasing appearances.

In addition to the novel features and advantages mentioned above, other features and advantages will be readily apparent from the following descriptions of the drawings and exemplary embodiments.

### BRIEF DESCRIPTION OF THE DRAWINGS

FIG. 1 is a schematic diagram of the principal components of an exemplary embodiment of the present invention.

FIG. 2 is a schematic diagram of the principal components of another exemplary embodiment of the present invention.

FIG. 3 illustrates the method steps of an exemplary embodiment of the present invention.

### DETAILED DESCRIPTION OF EXEMPLARY EMBODIMENT(S)

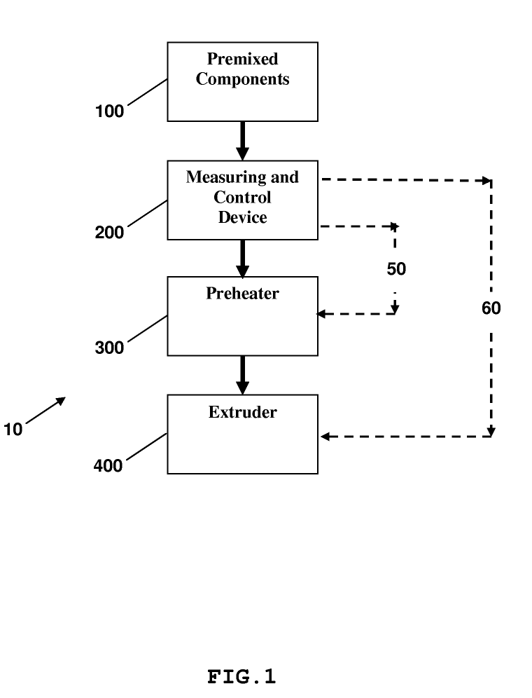

FIG. 1 illustrates an example of system 10 of the present invention. Selected premixed composite material components 100 of the desired composite material are introduced to a measuring and control means, such as device 200, which first measures the quantity of components 100 being processed. Examples of components 100 may include a thermoplastic resin and a cellulosic filler material, such as polyethylene and wood flour, respectively. Another example of components 100 may include a thermoplastic resin and a cellulosic filler material, such as polyvinyl chloride and wood flour, respectively. Numerous other materials are also available for manufacturing composites. The measuring and control device 200 subsequently produces an output control signal that may communicate with a means to preheat the composite material components, such as a preheater 300 via a control path 50 and/or with a means to form the desired final product, such as an extruder 400 via control path 60 to actively control “on-the-fly” in a “real-time” mode the quantity of components 100 being consumed to produce the desired final product characteristics. Although not limited to such devices, FIG. 1 illustrates the use of a preheater and extruder as examples of means to preheat and form the desired final product. Preheater 300 may optionally be used to bring the temperature of components 100 to a desired temperature conducive to extrusion in a subsequently connected extruder 400. It should be noted, as would be obvious by those skilled in the art, that other system components, such mixers, stirrers, humidity control devices, chillers, conveyors, and other processing devices may be employed, controlled, and inserted at any point in the system and in any combination and connection thereof with other system components, as desired, and that other means of forming the product other than extrusion, such as compression molding, injection molding, casting, and rotational molding fall within the scope of the present invention. Other suitable systems may also be employed. Measuring and control device 200 may employ any method or combination of methods by which to provide real-time quantitative measurements of components 100, wherein such methods may be, but are not limited to, optical, acoustical, and gravimetrical methods. A gravimetrical method is one preferred method, wherein components 100 are dynamically weighed and compared to desired set-point levels as defined by the particular product characteristics desired. Typically, the output signals 50 and/or 60 may be respectively used to control the speed of material handling feed screws provided within the preheater 300 and/or extruder 400 to produce a final product with uniform characteristics. Examples of commercially marketed gravimetric process control elements are Saveomat systems, by iNOEX, Bad Oeynhausen, Germany and AccuRate® systems produced by Schenck, Whitewater, Wis. Exemplary means for preheating selected composite material premixed components may comprise, but not be limited to, any adequate heat source such as electrical, chemical (such as combustible fuels or exothermic reactions), and/or frictional methods.

Examples of cellulosic filler materials may include any combination of sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, bagasse, plant fibers, bamboo fiber, palm fiber, kenaf, flax, or any other similar or suitable materials. Examples of thermoplastic resins may include multilayer films, high density polyethylene (HDPE), polypropylene, polyvinyl chloride (PVC), low density polyethylene (LDPE), chlorinated polyvinyl chloride (CPVC), acrylonitrile butadiene styrene (ABS), ethyl-vinyl acetate, other similar or suitable copolymers, other similar or suitable plastic materials, or formulations that incorporate any of the aforementioned plastic materials.

The use of other materials to make the desired composite product may include one or more materials including, but not limited to, inorganic fillers, cross-linking agents, thermosetting materials, process aids, lubricants, accelerators, inhibitors, enhancers, compatibilizers, stabilizers, acrylic modifiers, pigments, weathering additives, foaming agents, blowing agents, rubber, other plastics, and other similar or suitable materials that may be used in cellulosic and/or thermoplastic compounds.

Stabilizer(s) may be employed to limit or prevent the breakdown of the plastic material during molding. Examples of stabilizers include tin stabilizers, lead and metal soaps such as barium, cadmium, and zinc, and other similar or suitable materials.

Internal or external lubricant(s) may aid in the molding process. Lubricants may be added to the plastic material to assist the reinforced composite through, for example, an extruder, compounder, or other molding machine, and to help facilitate mold release. Examples of lubricants include zinc stearate, calcium stearate, esters, amide wax, paraffin wax, ethylene bis-stearamide, and other similar or suitable materials.

Process aid(s) may aid in the fusion of the compound. Examples of process aids include acrylic process aids and other similar or suitable materials for improving the fusion of the compound. R&H K-120N and R&H K-175 are examples of acrylic process aids that are available from Rohm & Haas.

Acrylic modifier(s) may improve the physical characteristics of the compound. One example of an impact modifier is Arkema P530. Another example of an acrylic modifier is R&H K-400, which is available from Rohm & Haas. R&H K-400 is a high molecular weight acrylic modifier.

Inorganic filler(s) may be used to increase the bulk density of the reinforced composite. The use of inorganic filler may also improve the ability to process the reinforced composite, thereby allowing for higher rates of manufacture (e.g., extrusion). Inorganic filler may also allow the reinforced composite to be molded into articles having reduced moisture sensitivity and reduced flame and smoke spread. Examples of inorganic fillers include talc, calcium carbonate, kaolin clay, magnesium oxide, titanium dioxide, silica, mica, barium sulfate, wollastanite, acrylics, and other similar or suitable materials.

Blowing agent(s) may be used to reduce the cost (e.g., by reducing the amount of polymer used in the composite) and weight of the composite material. A blowing agent may be an endothermic or exothermic blowing agent. An example of a chemical endothermic blowing agent is Hydrocerol BIH (i.e., sodium bicarbonate/citric acid), which is available from Clariant Corp., whereas an example of a chemical exothermic foaming agent is azodicarbonamide, which is available from Uniroyal Chemical Co.

The use of thermosetting materials may, for example, reduce moisture absorption and increase the strength of products manufactured from the reinforced composite material. Examples of thermosetting materials include polyurethanes (e.g., isocyanates), phenolic resins, unsaturated polyesters, epoxy resins, and other similar or suitable materials. Combinations of the aforementioned materials are also examples of thermosetting materials.

Pigments may be used to give the composite a desired color (e.g., white, cedar, gray, and redwood). Examples of pigments include titanium dioxide, iron oxide, and other similar or suitable colorant additives. For instance, components may be molded in any desired color to match the appearance of a fence, deck, or rail, for example, and may also have a pattern or texture formed on the outside face so as to match the texture or pattern of a fence, deck, or rail, for example.

Titanium dioxide is also an example of a weathering additive. Other similar or suitable weathering additives include, but are not limited to, other ultraviolet absorbers. Examples of other ultraviolet absorbers include organic chemical agents such as benzophenone and benzotriazole types.

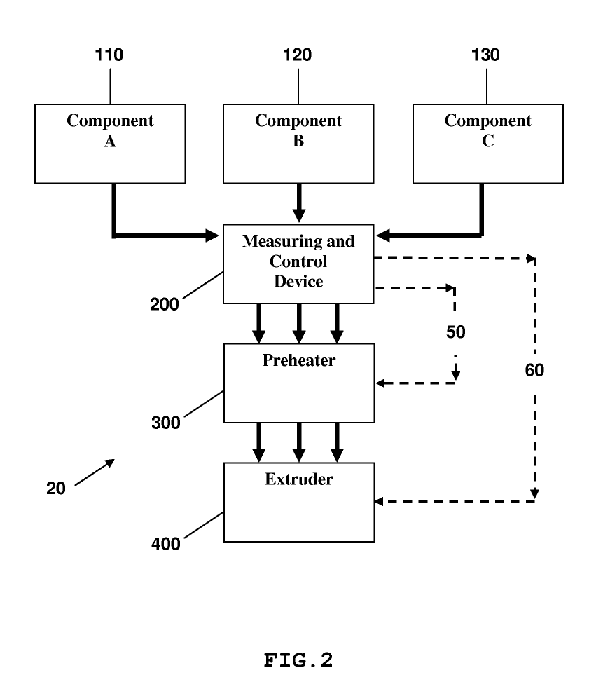

FIG. 2 illustrates an example of system 20 of the present invention showing another exemplary embodiment wherein the measurement and control device 200 is used to individually measure separate constituent components (for example, 110, 120, and 130) used to manufacture the final composite product, which is in contrast to system 10, shown in FIG. 1, wherein the measurement and control device 200 measure a mixture of components. It should be noted that components 110, 120, and 130 are examples only and that the components therein represented may be of any number as needed and may comprise any components or combination of components desired. The measuring and control device 200 produces an output control signal that may communicate with a preheater 300 via a control path 50 and/or an extruder 400 via control path 60 to actively control “on-the-fly” in a “real-time” mode the quantity of components 110, 120, and 130 used to produce the desired final product characteristics. Again, exemplary means for preheating selected composite material components may comprise, but not be limited to, any adequate heat source such as electrical, chemical (such as combustible fuels or exothermic reactions), and frictional methods. Also, it should be again noted that other system components, such mixers, stirrers, humidity control devices, chillers, conveyors, and other processing devices, may be employed, controlled, and inserted at any point in the system and in any combination and connection thereof with other system components, as desired, and that other means of forming the product other than extrusion, such as compression molding, injection molding, casting, and rotational molding, for example, also fall within the scope of the present invention.

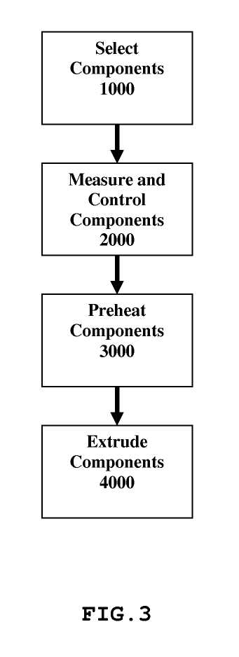

FIG. 3 illustrates an example of the method steps to manufacture a composite component. Components of the desired composite material are selected in step 1000 where they are subsequently measured in step 2000 and introduced into, for example, a preheater where they are preheated in step 3000 and finally introduced into a forming device, such as an extruder, to produce the desired product as accomplished by forming step 4000. The preheater and/or extruder functions in steps 3000 and/or 4000 may be controlled by the measuring device used during step 2000 to provide real-time adjustment to the processing steps in 3000 and/or 4000 to produce products having the desired uniform properties. It should again be noted by those skilled in the art that it is possible to add additional steps and apply process control subsequent to step 2000 to any other system component or components such mixers, stirrers, humidity control devices, chillers, and/or other processing devices, which may be employed, controlled, and inserted at any point in the system and in any combination and connection thereof with other system components, as desired.

Exemplary embodiments of the present invention beneficially provide a system and method by which to produce superior composite materials having desired and substantially uniform properties, which may, for example, be useful for making decking, railing, or fencing components including, but not limited to, rails, planks, balusters, squash blocks, support rails, posts, post covers, and other similar or suitable components. Nevertheless, while exemplary embodiments of the present invention may be particularly useful for making decking, fencing, and railing components, it should be recognized that the composite material produced by exemplary embodiments of the present invention may be useful for manufacturing other types of indoor and outdoor components. Examples of components that can be made with exemplary embodiments of the present invention include, but are not limited to, fence components, furniture components, cabinet components, storage device components, lawn edging components, flower box components, floor components, baseboards, roof components, wall covering components, building siding components, basement floor components, basement wall covering components, interior and exterior decorative house molding components, crown molding components, chair rail components, picture frame components, porch components, deck components, railing components, window molding components, window components, window frames, door components, door frames, door moldings, posts, boards, and other suitable indoor and outdoor items.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A system for producing composite material products from selected composite material components, said system comprising:
at least one means adapted to measure and control the consumption of said composite material components;
at least one means adapted to preheat said composite material components; and
at least one means adapted to form said composite material products;
wherein said means to measure and control the consumption of said composite material components is adapted to communicate with said preheater means and/or said forming means to form said composite material components into composite material products having desired and substantially uniform properties.

2. The system of claim 1 wherein said selected composite material components comprise at least one thermoplastic resin and at least one filler.

3. The system of claim 1 wherein said selected composite material components are adapted to be premixed prior to measurement and control by said means to measure and control the consumption of said composite material components.

4. The system of claim 1 wherein said selected composite material components are adapted to be separately measured and controlled by said means to measure and control the consumption of said composite material components.

5. The system of claim 1 wherein said means to measure and control the consumption of said composite material components is adapted to use methods selected from the group consisting of optical, acoustical, gravimetrical, and combinations thereof.

6. The system of claim 1 wherein said means to preheat said composite material components is adapted to use methods selected from the group consisting of electrical, chemical, frictional, and combinations thereof.

7. The system of claim 1 wherein said means to form said composite material products is adapted to use methods selected from the group consisting of extrusion, injection molding, casting, and rotational molding.

8. A system for producing composite material products from selected composite material components, said system comprising:
at least one means adapted to measure and control the consumption of said composite material components; and
at least one means adapted to form said composite material components into composite material products;
wherein said means to measure and control the consumption of said composite material components is adapted to communicate with said means to form said composite material products to produce said products having desired and substantially uniform properties.

9. The system of claim 8 wherein said selected composite material components comprise at least one thermoplastic resin and at least one filler.

10. The system of claim 8 wherein said selected composite material components are adapted to be premixed prior to measurement and control by said means to measure and control the consumption of said composite material components.

11. The system of claim 8 wherein said selected composite material components are adapted to be separately measured and controlled by said means to measure and control the consumption of said composite material components.

12. The system of claim 8 wherein said means to measure and control the consumption of said composite material components is adapted to use methods selected from the group consisting of optical, acoustical, gravimetrical, and combinations thereof.

13. The system of claim 8 wherein said means to preheat said composite material components is adapted to use methods selected from the group consisting of electrical, chemical, frictional, and combinations thereof.

14. The system of claim 8 wherein said means to form said composite material products is adapted to use methods selected from the group consisting of extrusion, injection molding, casting, and rotational molding.

15. A method for producing composite material products from selected composite material components, said method comprising the steps of:
selecting said composite material components;
measuring and controlling said composite material components; and
forming said composite material products,
whereby said composite material products have desired and substantially uniform properties.

16. The method of claim 15 wherein said selected composite material components are premixed prior to said measurement and control step.

17. The method of claim 15 wherein said selected composite material components are separately measured and controlled during said measurement and control step.

18. The method of claim 15 wherein said step used to measure and control the consumption of said composite material components comprises methods selected from the group consisting of optical, acoustical, gravimetrical, and combinations thereof.

19. The method of claim 15 wherein said step used to preheat said composite material components comprises methods selected from the group consisting of electrical, chemical, frictional, and combinations thereof.

20. The method of claim 15 wherein said step used to form said composite material products comprises methods selected from the group consisting of extrusion, injection molding, casting, and rotational molding.
